(19) United States
(12) Patent Application Publication
(10) Pub. No.: US 2024/0321114 A1
(43) Pub. Date: Sep. 26, 2024

(54) METHOD AND SYSTEM TO DETECTION OF RESTRICTIVE OBSTACLES FOR THE OPTIMIZATION OF AIRCRAFT TAKEOFFS

(71) Applicant: HONEYWELL INTERNATIONAL INC., Charlotte, NC (US)

(72) Inventors: Ari Narayanan M, Madurai (IN); Nathan Krishna Moorthy, Bangalore (IN); Sivasankari Paramasivan, Madurai (IN)

(73) Assignee: HONEYWELL INTERNATIONAL INC., Charlotte, NC (US)

(21) Appl. No.: 18/318,013

(22) Filed: May 16, 2023

(30) Foreign Application Priority Data
Mar. 24, 2023 (IN) 202311021034

(51) Int. Cl. G08G 5/00; G08G 5/04

(52) U.S. Cl. CPC G08G 5/0021; G08G 5/003; G08G 5/045

(57) ABSTRACT

A method and system for identifying a restrictive obstacle for a flight plan of an aircraft has been developed. First, both static obstacle data and temporary obstacle data is retrieved for a runway used during takeoff of the aircraft. The relevant data is identified for clearance of the static obstacles and the temporary obstacles. The distance and elevation of the static obstacles and the temporary obstacles is computed from a departure point of the runway. Next, the clearance data required for the aircraft is computed for each of the static obstacles and the temporary obstacles. The most restrictive obstacle is identified based on the clearance data for each of the static obstacles and the temporary obstacles and displayed to the pilot of the aircraft.

### CROSS REFERENCE TO RELATED APPLICATION

The present application claims benefit of prior filed India Provisional Patent Application No. 202311021034, filed Mar. 24, 2023, which is hereby incorporated by reference herein in its entirety.

### TECHNICAL FIELD

The present invention generally relates to aircraft operations, and more particularly relates to a method for the detection of restrictive obstacles for the optimization of aircraft takeoffs.

### BACKGROUND

During aircraft pre-flight departure planning, the analysis for obstacle clearance analysis is a significant task. As part of typical flight planning, a pilot retrieves obstacle information affecting the flight path from the charts and feeds a computer system for obstacle clearance performance computations. However, this is an substantial crew workload in time and analysis. Hence, there is a need for a method and system for identifying a restrictive obstacle for a flight plan of an aircraft.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A method is provided for identifying a restrictive obstacle for a flight plan of an aircraft. The method comprises: retrieve static obstacle data for a runway used during takeoff of the aircraft; retrieve temporary obstacle data for the runway used during the takeoff of the aircraft; identify the relevant data for clearance of the static obstacles and the temporary obstacles; compute the distance and elevation of the static obstacles and the temporary obstacles from a departure point of the runway; compute the clearance data required for the aircraft for each of the static obstacles and the temporary obstacles; identify the most restrictive obstacle based on the clearance data for each of the static obstacles and the temporary obstacles; and display the most restrictive obstacle and the clearance data required for the aircraft to a pilot of the aircraft.

A system is provided for identifying a restrictive obstacle for a flight plan of an aircraft. The system comprises: a database that, stores static obstacle data for a runway used during takeoff of the aircraft, and stores temporary obstacle data for the runway used during the takeoff of the aircraft; a flight management system (FMS) onboard the aircraft, where the FMS, retrieves static obstacle data for a runway used during takeoff of the aircraft, retrieves temporary obstacle data for the runway used during the takeoff of the aircraft, identifies the relevant data for clearance of the static obstacles and the temporary obstacles, computes the distance and elevation of the static obstacles and the temporary obstacles from a departure point of the runway, computes the clearance data required for the aircraft for each of the static obstacles and the temporary obstacles, and identifies the most restrictive obstacle based on the clearance data for each of the static obstacles and the temporary obstacles; and a display that, displays the most restrictive obstacle and the clearance data required for the aircraft to a pilot of the aircraft.

Furthermore, other desirable features and characteristics of the method for identifying a restrictive obstacle for a flight plan of an aircraft will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 shows a diagram of aircraft computer system in accordance with the disclosed embodiments;

FIG. 2 shows a functional block diagram of a computing device in accordance with the disclosed embodiments;

FIG. 3 shows a block diagram of a system for identifying a restrictive obstacle for a flight plan of an aircraft in accordance with the disclosed embodiments;

FIG. 4 shows a function path 400 is shown for identifying a restrictive obstacle as listed in a notice to airmen (NOTAM) in accordance with the disclosed embodiments; and

FIG. 5 shows a flowchart for a method for identifying a restrictive obstacle for a flight plan of an aircraft in accordance with the disclosed embodiments.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

A method and system for identifying a restrictive obstacle for a flight plan of an aircraft has been developed. First, both static obstacle data and temporary obstacle data is retrieved for a runway used during takeoff of the aircraft. The relevant data is identified for clearance of the static obstacles and the temporary obstacles. The distance and elevation of the static obstacles and the temporary obstacles is computed from a departure point of the runway. Next, the clearance data required for the aircraft is computed for each of the static obstacles and the temporary obstacles. The most restrictive obstacle is identified based on the clearance data for each of the static obstacles and the temporary obstacles and displayed to the pilot of the aircraft.

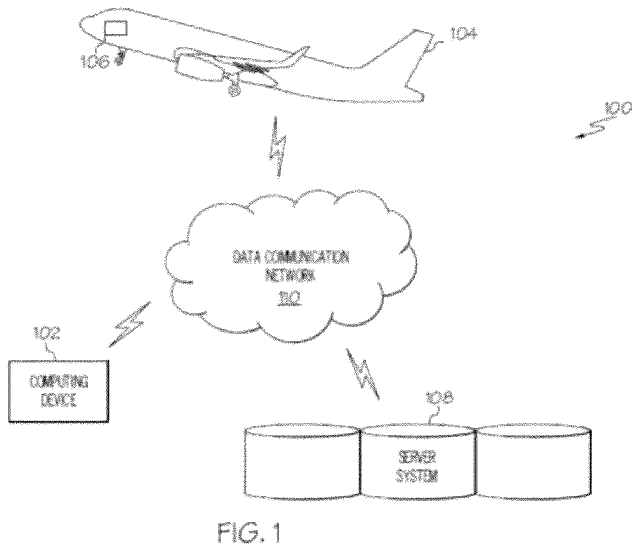

Turning now to the figures, FIG. 1 is a diagram of aircraft computer system 100, in accordance with the disclosed embodiments. The computing device 102 may be implemented by any computing device that includes at least one processor, some form of memory hardware, a user interface, and communication hardware. For example, the computing device 102 may be implemented using a personal computing device, such as a tablet computer, a laptop computer, a personal digital assistant (PDA), a smartphone, or the like. In this scenario, the computing device 102 is capable of storing, maintaining, and executing Electronic Flight Bag (EFB) applications. In other embodiments, the computing device 102 may be implemented using a computer system onboard the aircraft 104.

The aircraft 104 may be implemented as an airplane, helicopter, spacecraft, hovercraft, or the like. The one or more avionics systems 106 may include a Flight Management System (FMS), navigation devices, weather detection devices, radar devices, communication devices, brake systems, and/or any other electronic system or avionics system used to operate the aircraft 104. Data obtained from the one or more avionics systems 106 may include, without limitation: flight data, aircraft heading, aircraft speed, aircraft position, altitude, descent rate, position of air spaces surrounding a current flight plan, activity of air spaces surrounding a current flight plan, or the like.

The server system 108 may include any number of application servers, and each server may be implemented using any suitable computer. In some embodiments, the server system 108 includes one or more dedicated computers. In some embodiments, the server system 108 includes one or more computers carrying out other functionality in addition to server operations. The server system 108 may store and provide any type of data in a database. Such data may include, without limitation: flight plan data, aircraft parameters, avionics data and associated user actions, and other data compatible with the computing device 200.

The computing device 102 is usually located onboard the aircraft 104, and the computing device 102 communicates with the one or more avionics systems 106 via wired and/or wireless communication connection. The computing device 102 and the server system 108 may both be located onboard the aircraft 104. In other embodiments, the computing device 102 and the server system 108 may be disparately located, and the computing device 102 communicates with the server system 108 via the data communication network 110 and/or via communication mechanisms onboard the aircraft 104.

The data communication network 110 may be any digital or other communications network capable of transmitting messages or data between devices, systems, or components. In certain embodiments, the data communication network 110 includes a packet switched network that facilitates packet-based data communication, addressing, and data routing. The packet switched network could be, for example, a wide area network, the Internet, or the like. In various embodiments, the data communication network 110 includes any number of public or private data connections, links or network connections supporting any number of communications protocols. The data communication network 110 may include the Internet, for example, or any other network based upon TCP/IP or other conventional protocols. In various embodiments, the data communication network 110 could also incorporate a wireless and/or wired telephone network, such as a cellular communications network for communicating with mobile phones, personal digital assistants, and/or the like. The data communication network 110 may also incorporate any sort of wireless or wired local and/or personal area networks, such as one or more IEEE 802.3. IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

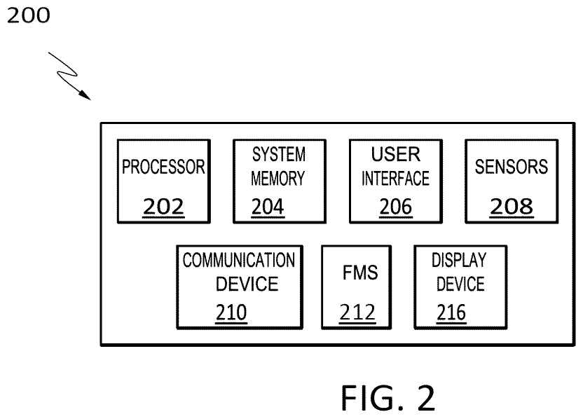

FIG. 2 is a functional block diagram of a computing device 200, in accordance with the disclosed embodiments. It should be noted that the computing device 200 can be implemented with the computing device 102 depicted in FIG. 1. In this regard, the computing device 200 shows certain elements and components of the computing device 102 in more detail.

The computing device 200 generally includes, without limitation: a processor 202; system memory 204; a user interface 206; a plurality of sensors 208; a communication device 210; a flight management system (FMS) 212; and a display device 216. These elements and features of the computing device 200 may be operatively associated with one another, coupled to one another, or otherwise configured to cooperate with one another as needed to support the desired functionality. For case of illustration and clarity, the various physical, electrical, and logical couplings and interconnections for these elements and features are not depicted in FIG. 2. Moreover, it should be appreciated that embodiments of the computing device 200 will include other elements, modules, and features that cooperate to support the desired functionality. For simplicity, FIG. 2 only depicts certain elements that are described in more detail below.

The processor 202 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the processor 202 may be realized as one or more microprocessors, controllers, microcontrollers, or state machines. Moreover, the processor 202 may be implemented as a combination of computing devices, e.g., a combination of digital signal processors and microprocessors, a plurality of microprocessors, one or more microprocessors in conjunction with a digital signal processor core, or any other such configuration.

The processor 202 is communicatively coupled to the system memory 204. The system memory 204 is configured to store any obtained or generated data associated with generating alerts to redirect user attention from the computing device 200 to a critical or high-priority flight situation. The system memory 204 may be realized using any number of devices, components, or modules, as appropriate to the embodiment. Moreover, the computing device 200 could include system memory 204 integrated therein and/or a system memory 204 operatively coupled thereto, as appropriate to the particular embodiment. In practice, the system memory 204 could be realized as RAM memory, flash memory, EPROM memory, EEPROM memory, registers, a hard disk, a removable disk, or any other form of storage medium known in the art. In certain embodiments, the system memory 204 includes a hard disk, which may also be used to support functions of the computing device 200. The system memory 204 can be coupled to the processor 202 such that the processor 202 can read information from, and write information to, the system memory 204. In the alternative, the system memory 204 may be integral to the processor 202. As an example, the processor 202 and the system memory 204 may reside in a suitably designed application-specific integrated circuit (ASIC).

The user interface 206 may include or cooperate with various features to allow a user to interact with the computing device 200. Accordingly, the user interface 206 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the computing device 200. For example, the user interface 206 could be manipulated by an operator to provide flight data parameters during the operation of electronic flight bag (EFB) applications, as described herein.

In certain embodiments, the user interface 206 may include or cooperate with various features to allow a user to interact with the computing device 200 via graphical elements rendered on a display element (e.g., the display device 216). Accordingly, the user interface 206 may initiate the creation, maintenance, and presentation of a graphical user interface (GUI). In certain embodiments, the display device 216 implements touch-sensitive technology for purposes of interacting with the GUI. Thus, a user can manipulate the GUI by moving a cursor symbol rendered on the display device 216, or by physically interacting with the display device 216 itself for recognition and interpretation, via the user interface 206.

The plurality of sensors 208 is configured to obtain data associated with active use of the computing device 200, and may include, without limitation: touchscreen sensors, accelerometers, gyroscopes, or the like. Some embodiments of the computing device 200 may include one particular type of sensor, and some embodiments may include a combination of different types of sensors. Generally, the plurality of sensors 208 provides data indicating whether the computing device 200 is currently being used. Touchscreen sensors may provide output affirming that the user is currently making physical contact with the touchscreen (e.g., a user interface 206 and/or display device 216 of the computing device 200), indicating active use of the computing device. Accelerometers and/or gyroscopes may provide output affirming that the computing device 200 is in motion, indicating active use of the computing device 200.

The communication device 210 is suitably configured to communicate data between the computing device 200 and one or more remote servers and one or more avionics systems onboard an aircraft. The communication device 210 may transmit and receive communications over a wireless local area network (WLAN), the Internet, a satellite uplink/downlink, a cellular network, a broadband network, a wide area network, or the like. As described in more detail below, data received by the communication device 210 may include, without limitation: avionics systems data and aircraft parameters (e.g., a heading for the aircraft, aircraft speed, altitude, aircraft position, ascent rate, descent rate, a current flight plan, a position of air spaces around a current flight plan, and activity of the air spaces around a current flight plan), and other data compatible with the computing device 200. Data provided by the communication device 210 may include, without limitation, requests for avionics systems data, alerts and associated detail for display via an aircraft onboard display, and the like.

The display device 216 is configured to display various icons, text, and/or graphical elements associated with alerts related to situations requiring user attention, wherein the situations are associated with a device or system that is separate and distinct from the computing device 200. In an exemplary embodiment, the display device 216 and the user interface 206 are communicatively coupled to the processor 202. The processor 202, the user interface 206, and the display device 216 are cooperatively configured to display, render, or otherwise convey one or more graphical representations or images associated with high-priority or critical flight situation alerts on the display device 216, as described in greater detail below. In an exemplary embodiment, the display device 216 is realized as an electronic display configured to graphically display critical flight situation alerts and associated detail, as described herein. In some embodiments, the computing device 200 is an integrated computer system onboard an aircraft, and the display device 216 is located within a cockpit of the aircraft, and is thus implemented as an aircraft display. In other embodiments, the display device 216 is implemented as a display screen of a standalone, personal computing device (e.g., laptop computer, tablet computer). It will be appreciated that although the display device 216 may be implemented using a single display, certain embodiments may use additional displays (i.e., a plurality of displays) to accomplish the functionality of the display device 216 described herein.

The FMS 212, as is generally known, is a specialized computer that automates a variety of in-flight tasks such as in-flight management of the flight plan. Using various sensors such as global positioning system (GPS), the FMS determines the aircraft's position and guides the aircraft along its flight plan using its navigation database. From the cockpit, the FMS is normally controlled through a visual display device such as a control display unit (CDU) which incorporates a small screen, a keyboard or a touchscreen. The FMS displays the flight plan and other critical flight data to the aircrew during operation.

The FMS may have a built-in electronic memory system that contains a navigation database. The navigation database contains elements used for constructing a flight plan. In some embodiments, the navigation database may be separate from the FMS and located onboard the aircraft while in other embodiments the navigation database may be located on the ground and relevant data provided to the FMS via a communications link with a ground station. The navigation database used by the FMS may typically include: waypoints/intersections; airways; radio navigation aids/navigation beacons; airports; runway; standard instrument departure (SID) information; standard terminal arrival (STAR) information; holding patterns; and instrument approach procedures. Additionally, other waypoints may also be manually defined by pilots along the route.

The flight plan is generally determined on the ground before departure by either the pilot or a dispatcher for the owner of the aircraft. It may be manually entered into the FMS or selected from a library of common routes. In other embodiments the flight plan may be loaded via a communications data link from an airline dispatch center. During preflight planning, additional relevant aircraft performance data may be entered including information such as: gross aircraft weight; fuel weight and the center of gravity of the aircraft. The aircrew may use the FMS to modify the plight flight plan before takeoff or even while in flight for variety of reasons. Such changes may be entered via the CDU. Once in flight, the principal task of the FMS is to accurately monitor the aircraft's position. This may use a GPS, a VHF omnidirectional range (VOR) system, or other similar sensor in order to determine and validate the aircraft's exact position. The FMS constantly cross checks among various sensors to determine the aircraft's position with accuracy.

Additionally, the FMS may be used to perform advanced vertical navigation (VNAV) functions. The purpose of VNAV is to predict and optimize the vertical path of the aircraft. The FMS provides guidance that includes control of the pitch axis and of the throttle of the aircraft. In order to accomplish these tasks, the FMS has detailed flight and engine model data of the aircraft. Using this information, the FMS may build a predicted vertical descent path for the aircraft. A correct and accurate implementation of VNAV has significant advantages in fuel savings and on-time efficiency.

Various embodiments automatically retrieve the obstacle information such as static obstacle data including obstacle elevation and obstacle distance and standard instrument departure (SID) obstacle data including virtual obstacle gradient and elevation. The data is retrieved by scanning all the obstacle information sources including any notice to airmen (NOTAM) for all the runways in that airport. The NOTAMs are decoded and used to compute the relevant data for any temporary obstacle clearance computations. The obstacle distance and elevation are computed from the departure end of the runway and used to determine the list of identified obstacles that needs to be considered. The most restrictive obstacle is identified is for each runway is identified and its obstacle clearance data will be computed and displayed to the crew/dispatcher. This has the advantages of helping the crew to choose the most optimum runway/SID for takeoff while reducing crew workload, enhancing safety by automatic obstacle clearance analysis and identification of the most restrictive obstacle affecting the flight path. Additionally, time in the cockpit dealing flight planning for obstacle clearance in reduced and crew efficiency is increased since obstacle clearance takes a lot of crew time during dispatch.

In some embodiments, the method involves obtaining obstacle details such as obstacle distance (in feet) from the departure end of the runway and obstacle elevation above mean sea level (MSL). Also, obtaining the virtual obstacle details such as SID gradient (e.g., Feet/Nautical Mile) and SID Elevation above MSL. Next, the height zero and distance zero for an obstacle and virtual obstacle individually is computed from the reference zero (e.g., the point at which the aircraft is 35 feet above the runway). The available gross gradient is computed using the obstacle details, aircraft characteristics, runway characteristics and atmospheric characteristics individually for each obstacle. The required gross gradient is also computed using the obstacle details, aircraft characteristics, runway characteristics and atmospheric characteristics individually for each obstacle. The required and available gross gradients are compared for each obstacle and the most limiting obstacle is identified (i.e., obstacle with highest obstacle gradient).

If the available gradient is greater than required gradient and if available gradient is greater, proceeding with takeoff is suggested. If available gradient is lesser than the required gradient, then takeoff is not possible given the current conditions. If it is determined that the available gradient is not sufficient to clear the obstacle with the preset clearance height in the current runway, other available runways in the airport are checked for their suitability. This is repeated until a runway is found where takeoff is possible with the required obstacle clearance criteria.

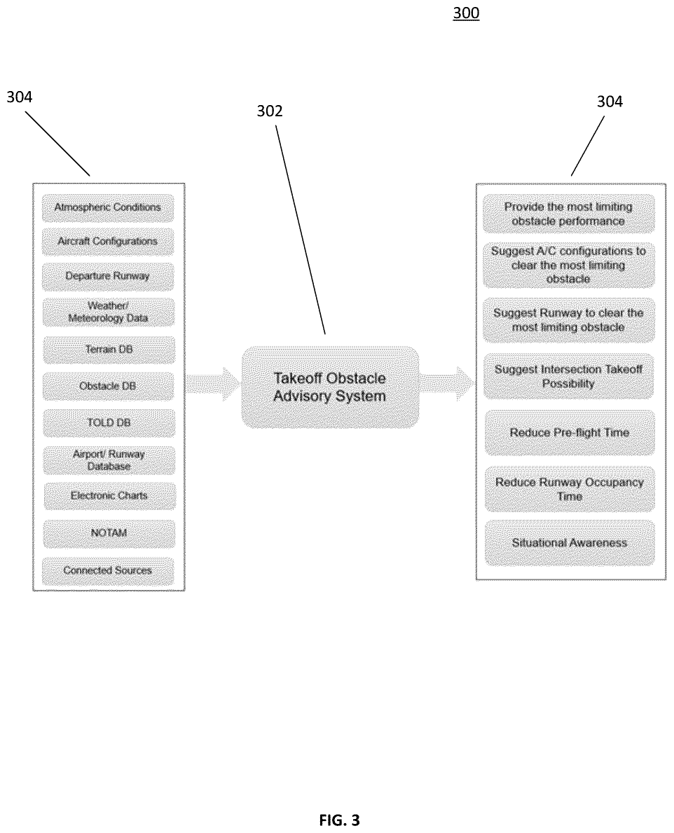

Turning now to FIG. 3, a block diagram 300 is shown of a system for identifying a restrictive obstacle for a flight plan of an aircraft in accordance with the disclosed embodiments. The Takeoff Obstacle Advisory System 302 retrieves relevant data from multiple sources 304 including: atmospheric conditions; aircraft conditions; the departure runway; weather/meteorological data; terrain databases; obstacle databases; takeoff and landing (TOLD) databases; airport/runway databases; electronic charts; NOTAMs and other connected sources. The system 302 processes the relevant data and delivers information to the pilot of the aircraft, including: the characteristics of the most limiting obstacle; suggested aircraft configuration to clear the most limiting obstacle; suggested runway to clear the most limiting obstacle; suggested intersection takeoff; etc.

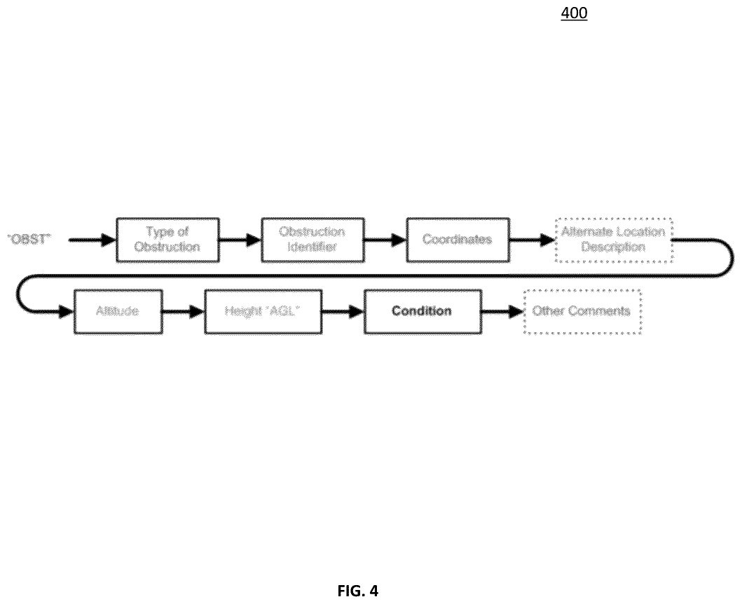

NOTAMs are of particular interest since they typically cover temporary obstacles (e.g., construction cranes, etc.). The data retrieved from the obstacle charts is a static data and typically does not cover the NOTAMs. Turning now to FIG. 4, a function path 400 is shown for identifying a restrictive obstacle as listed in a NOTAM in accordance with the disclosed embodiments. The NOTAM protocol will parse the temporary obstacle NOTAM (“OBST”) and compute the relevant information for the obstacle clearance. The OBST will be identified for the type of obstruction, an identifier along with coordinates and any other alternative location description. Also included will be the OBST altitude, height (AGL) and condition along with any other comments.

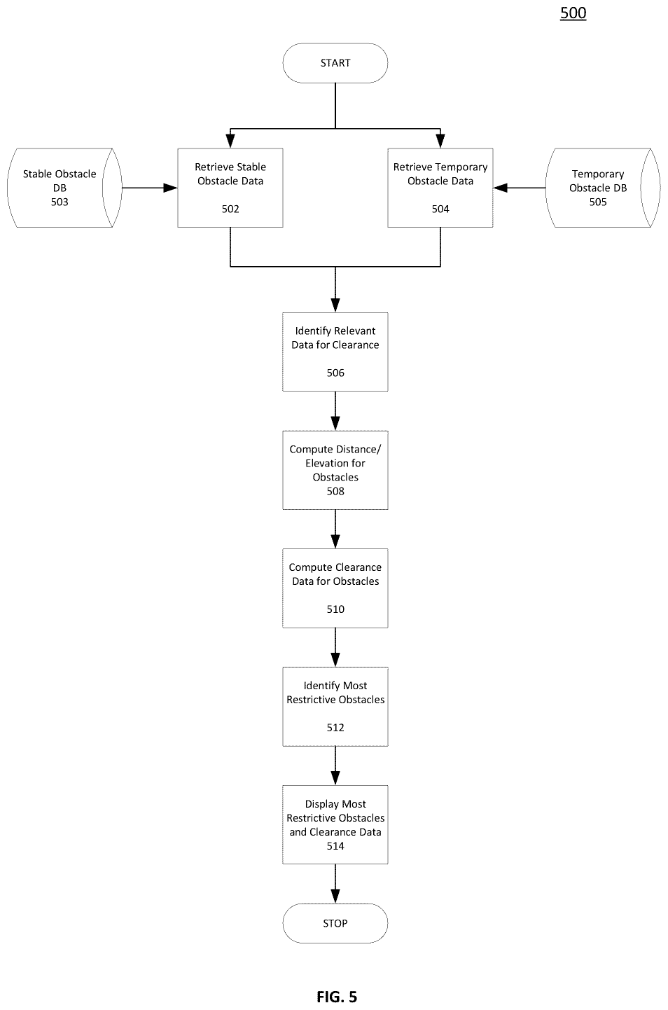

Turning now to FIG. 5, a flowchart 500 is shown for a method for identifying a restrictive obstacle for a flight plan of an aircraft in accordance with the disclosed embodiments. First, both static obstacle data 502 and temporary obstacle data 504 is retrieved for a runway used during takeoff of the aircraft. In some embodiments, this data is retrieved from the appropriate databases 503 and 505. The relevant data is identified for clearance of the static obstacles and the temporary obstacles 506. The distance and elevation of the static obstacles and the temporary obstacles is computed from a departure point of the runway 508. Next, the clearance data required for the aircraft is computed for each of the static obstacles and the temporary obstacles 510. The most restrictive obstacle is identified based on the clearance data for each of the static obstacles and the temporary obstacles 512 and displayed to the pilot of the aircraft 514.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for identifying a restrictive obstacle for a flight plan of an aircraft, comprising:
retrieve static obstacle data for a runway used during takeoff of the aircraft;
retrieve temporary obstacle data for the runway used during the takeoff of the aircraft;
identify the relevant data for clearance of the static obstacles and the temporary obstacles;
compute the distance and elevation of the static obstacles and the temporary obstacles from a departure point of the runway;
compute the clearance data required for the aircraft for each of the static obstacles and the temporary obstacles;
identify the most restrictive obstacle based on the clearance data for each of the static obstacles and the temporary obstacles; and
display the most restrictive obstacle and the clearance data required for the aircraft to a pilot of the aircraft.

2. The method of claim 1, where the static obstacle data is retrieved from a database by a flight management system (FMS).

3. The method of claim 2, where the database is a terrain database.

4. The method of claim 2, where the database is an obstacle database.

5. The method of claim 2, where the database is a takeoff and landing (TOLD) database.

6. The method of claim 1, where the temporary obstacle data is retrieved from notices to airmen (NOTAMs).

7. The method of claim 1, where the relevant data for clearance comprises the elevation and distance to a static obstacle or temporary obstacle.

8. The method of claim 1, where the relevant data for clearance comprises standard instrument departure (SID) data.

9. The method of claim 8, where the SID data comprises a virtual gradient and elevation of a static obstacle or temporary obstacle.

10. A system for identifying a restrictive obstacle for a flight plan of an aircraft, comprising:
a database that,
stores static obstacle data for a runway used during takeoff of the aircraft, and
stores temporary obstacle data for the runway used during the takeoff of the aircraft;
a flight management system (FMS) onboard the aircraft, where the FMS,
retrieves static obstacle data for a runway used during takeoff of the aircraft,
retrieves temporary obstacle data for the runway used during the takeoff of the aircraft,
identifies the relevant data for clearance of the static obstacles and the temporary obstacles,
computes the distance and elevation of the static obstacles and the temporary obstacles from a departure point of the runway,
computes the clearance data required for the aircraft for each of the static obstacles and the temporary obstacles, and
identifies the most restrictive obstacle based on the clearance data for each of the static obstacles and the temporary obstacles; and
a display that,
displays the most restrictive obstacle and the clearance data required for the aircraft to a pilot of the aircraft.

11. The system of claim 10, where the static obstacle data is retrieved from a database by a flight management system (FMS).

12. The system of claim 11, where the database is a terrain database.

13. The system of claim 11, where the database is an obstacle database.

14. The system of claim 11, where the database is a takeoff and landing (TOLD) database.

15. The system of claim 10, where the temporary obstacle data is retrieved from notices to airmen (NOTAMs).

16. The system of claim 10, where the relevant data for clearance comprises the elevation and distance to a static obstacle or temporary obstacle.

17. The system of claim 10, where the relevant data for clearance comprises standard instrument departure (SID) data.

18. The system of claim 17, where the SID data comprises a virtual gradient and elevation of a static obstacle or temporary obstacle.
